(19) United States
(12) Patent Application Publication
(10) Pub. No.: US 2021/0274798 A1
(43) Pub. Date: Sep. 9, 2021

(54) PACKAGING FOR ACCLERATING MYOGLOBIN CONVERSION AND METHODS THEREOF

(71) Applicant: Cryovac, LLC, Charlotte, NC (US)

(72) Inventors: Preeta Datta, Charlotte, NC (US); Henry W. Stockley, Lake Wylie, SC (US)

(21) Appl. No.: 17/259,434

(22) PCT Filed: Jul. 12, 2019
(86) PCT No.: PCT/US2019/041513

§ 371 Date: Jan. 11, 2021

Related U.S. Application Data
(60) Provisional application No. 62/697,005, filed on Jul. 12, 2018.

(51) Int. Cl. A23B 4/10; B32B 27/08; B32B 27/30; B32B 27/32; B32B 27/36; B65D 81/28

(52) U.S. Cl. CPC A23B 4/10; B32B 27/08; B32B 27/306; B32B 27/32; B32B 2439/70; B65D 81/28; B32B 2307/514; B32B 2307/7244; B32B 2255/10; B32B 27/36

(57) ABSTRACT

A package for packaging a meat product. The package comprises a multilayer film with a food contact sealant layer and a food additive in an amount sufficient to capture oxygen bound to myoglobin on the surface of the meat product. The meat product may have a conversion rate of oxymyoglobin to deoxymyoglobin with less than 5% metmyoglobin remaining on the surface of the meat product within a time period of 36 hours or less. The present invention may also be used in a low oxygen environment package, such as vacuum skin packaging.

### BACKGROUND

The subject matter disclosed herein is in the technical field of food packaging. More particularly, the subject matter is in the technical field of high barrier packaging to accelerate myoglobin conversion in food.

Natural antioxidants are traditionally used as food additives to prevent rancidative oxidation and stabilize color. Dry vinegar, rosemary, bamboo leaf, olive pulp, grapeseed, green tea, jasmine tea, acerola, and tocopherols are all examples of natural antioxidants. Active components, such as polyphenols, catechins, ascorbic acid, etc. found in these natural antioxidants can capture oxygen from the environment and prevent the food from getting oxidized. These antioxidants are known to help maintain the oxymyoglobin color of fresh meats within an oxygenated atmosphere, by preventing or reducing free radicals that can lead to discoloration (metmyoglobin formation). While such additives are known to extend the color life of oxygenated red meats and enhance the stability of meat against oxidation, they are not known to capture oxygen bound to myoglobin or accelerate the conversion of oxymyoglobin to deoxymyoglobin.

The bright red color of fresh meat is due to oxymyoglobin color formation with absorption of atmospheric oxygen. When absorbed oxygen on the meat surface is partially depleted, a partial pressure of oxygen is created. This results in an intermediate pathway color known as metmyoglobin (brown color). The rate of the metmyoglobin side reaction is affected by a variety of factors such as storage temperature, the muscle type in the cut of meat, the film permeability to oxygen, etc. In high barrier vacuum skin packaging, the formation of metmyoglobin is highly accelerated and browning occurs within a couple of hours. On the other hand, conversion of metmyoglobin to deoxymyoglobin is a much slower process, particularly under refrigerated storage conditions required to prevent spoilage bacteria growth.

Vacuum skin packaging (VSP) or other forms of vacuum packaging of food and meat products is important when food products need oxygen barrier properties to preserve the food product, such as a meat product. A meat product is adversely affected by oxidation and would benefit from a low oxygen environment in order to extend shelf life. VSP is a process well known in the art using a thermoplastic packaging material to enclose a food product. The vacuum skin packaging process is in one sense a type of thermoforming process in which an article to be packaged serves as the mold for a forming web. An article may be placed on a rigid or semi-rigid support member, that can be flat or shaped, e.g., tray-shaped, bowl-shaped or cup-shaped (called “bottom” web), and the supported article is then passed to a chamber where a “top” web is first drawn upward against a heated dome and then draped down over the article. The movement of the top web is controlled by vacuum and/or air pressure, and in a vacuum skin packaging arrangement, the interior of the container is vacuumized before final welding of the top web to the bottom web.

There is a need to accelerate the conversion of oxymyoglobin to deoxymyoglobin of fresh meat to facilitate immediate shipment to retail grocery stores for sale. The brown metmyoglobin color is unacceptable for retail merchandising of meats, and delays in the conversion to deoxymyoglobin causes delays in shipment, loss of shelf life, and increase work in process (WIP). This need is also desired in low oxygen environments of meat product packaging, such as VSP.

### BRIEF SUMMARY

An advantage that may be realized in the practice of some disclosed embodiments is that natural food additives can accelerate the conversion of metmyoglobin (brown color) to deoxymyoglobin (purple color) of fresh red meat in a low oxygen environment. Certain cuts of meat can have extended periods of metmyoglobin retention.

In one exemplary embodiment, a package for packaging a fresh meat product is disclosed. The package may have a multilayer film with a food contact sealant layer comprising at least one member selected from the group consisting of polyolefins, ionomers, ethylene vinyl acetate (EVA), PET, and polyethylene. The package may also have a food additive in an amount sufficient to capture oxygen bound to myoglobin on the surface of the meat product. The meat product may have a conversion rate of oxymyoglobin to deoxymyoglobin, with less than 5% metmyoglobin remaining on the surface of the fresh meat product, within a time period of 36 hours or less.

The present invention is also directed to a method for the conversion of metmyoglobin to deoxymyoglobin on the surface of a meat product. The method may include providing a multilayer film comprising a food contact sealant layer comprising at least one member selected from the group consisting of polyolefins, ionomers, EVA, PET, and polyethylene. The method may further include a step of adding a food additive in an amount sufficient to capture oxygen bound to myoglobin on the surface of the meat product to the multilayer film. The method may even further include forming a barrier package from the multilayer film. The method may also include placing a meat product inside the barrier package, wherein the meat product contacts the food additive. The method may also include sealing the barrier package closed with the meat product inside the barrier package. The meat product may have a conversion rate of oxymyoglobin to deoxymyoglobin, with less than 5% metmyoglobin remaining on the surface of the meat product, within a time period of 36 hours or less.

The present invention is also directed to another method for the conversion of oxymyoglobin to deoxymyoglobin on the surface of a meat product. The method may include providing a multilayer film comprising a food contact sealant layer comprising at least one member selected from the group consisting of polyolefins, ionomers, EVA, PET, and polyethylene. The method may also include adding a food additive in an amount sufficient to capture oxygen bound to myoglobin on the surface of the meat product to the surface of the meat product. The method may further include forming a barrier package from the multilayer film. The method may even further include placing a meat product inside the barrier package, wherein the food additive has been added to the surface of the meat product before placing the meat product inside the barrier package. The method may include sealing the barrier package closed with the meat product inside the barrier package. The meat product may have a conversion rate of oxymyoglobin to deoxymyoglobin, with less than 5% metmyoglobin remaining on the surface of the fresh meat product, within a time period of 36 hours or less.

### DETAILED DESCRIPTION

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long standing patent law convention, the terms “a”, “an”, and “the” refer to “one or more” when used in the subject application, including the claims. Thus, for example, reference to “a formulation” includes a plurality of such formulations, and so forth.

Unless indicated otherwise, all numbers expressing quantities of components, reaction conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, percentage, and the like can encompass variations of, and in some embodiments, ±20%, in some embodiments ±10%, in some embodiments ±5%, in some embodiments ±1%, in some embodiments ±0.5%, in some embodiments ±0.1%, and in some embodiments ±0.01%, from the specified amount, as such variations are appropriated in the disclosed film, pouch, container, and methods.

“Outer layer” herein refers to what is typically an outermost, usually surface layer or skin layer of a multilayer film, although additional layers, coatings, and/or films can be adhered to it.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, sometimes referred to in the art as “copolyamides”. “Polyamide” specifically includes those aliphatic polyamides or copolyamides commonly referred to as e.g. polyamide 6 (homopolymer based on ε-caprolactam), polyamide 69 (homopolycondensate based on hexamethylene diamine and azelaic acid), polyamide 610 (homopolycondensate based on hexamethylene diamine and sebacic acid), polyamide 612 (homopolycondensate based on hexamethylene diamine and dodecandioic acid), polyamide 11 (homopolymer based on 11-aminoundecanoic acid), polyamide 12 (homopolymer based on ω-aminododecanoic acid or on laurolactam), polyamide 6/12 (polyamide copolymer based on ε-caprolactam and laurolactam), polyamide 6/66 (polyamide copolymer based on ε-caprolactam and hexamethylenediamine and adipic acid), polyamide 66/610 (polyamide copolymers based on hexamethylenediamine, adipic acid and sebacic acid), modifications thereof and blends thereof. Said term also includes crystalline or partially crystalline, aromatic or partially aromatic, polyamides.

“Polymer” herein refers to homopolymer, copolymer, terpolymer, etc. “Copolymer” herein includes copolymer, terpolymer, etc.

As used herein, the term “oriented” refers to a polymer-containing film which has been stretched at an elevated temperature (the orientation temperature), followed by being “set” in the stretched configuration by cooling the material therefore retaining the stretched dimensions. Upon subsequently heating unrestrained, unannealed, oriented polymer-containing material to its orientation temperature, heat shrinkage is produced almost to the original unstretched, i.e., pie-oriented dimensions. As used herein, “oriented” films are stretched in the solid state as contrasted to blown films which are stretched in the melt state. More particularly, the term “oriented”, as used herein, refers to oriented films and articles fabricated from oriented films, wherein the orientation can be produced in one or more of a variety of manners.

As used herein, the phrase “orientation ratio” refers to the multiplication product of the extent to which the plastic film material is expanded in several directions, usually two directions perpendicular to one another. Expansion in the machine direction is herein referred to as “drawing”, whereas expansion in the transverse direction is herein referred to as “stretching”. For films extruded through an annular die, stretching is usually obtained by cooling the extrudate to a solid state and (below the crystallization temperature), reheating the film to its softening temperature, and then introducing compressed air between two nip rolls to produce a standing trapped bubble. For such films, drawing is usually obtained by passing the film through two sets of powered nip rolls, with the downstream set having a higher surface speed than the upstream set, with the resulting draw ratio being the surface speed of the downstream set of nip rolls divided by the surface speed of the upstream set of nip rolls. The degree of orientation is also referred to as the orientation ratio, or sometimes as the “racking ratio”.

The term “meat product” refers to any myoglobin-containing or hemoglobin-containing tissue from an animal, such as beef, pork, veal, lamb, mutton, chicken or turkey; and game such as venison, quail, fish, seafood and duck. It can also be used on raw or processed foods. The meat product can be in a variety of forms including primal cuts, subprimal cuts, and/or retail cuts as well as ground, comminuted or mixed. The meat or meat product is preferably fresh, raw, uncooked meat, but also includes cooked meat, comingled meat, frozen, hard chilled, or thawed. Meat also refers to any meat that has been subjected to other irradiative, biological, chemical and/or physical treatments. The suitability of any particular such treatment can be determined without undue experimentation in view of the present disclosure.

As used herein, the term “package” refers to packaging materials configured around a product being packaged. The phrase “packaged product,” as used herein, refers to the combination of a product that is surrounded by a packaging material.

As used herein, the noun “bond” and the verb “to bond” and “bonded” include all forms of bonding, including the many forms of heat sealing (e.g., impulse sealing, laser sealing, trim sealing, etc.) as well as adhesive bonding. As used herein, the terms “bond” and “seal” are used interchangeably, both covering bonding by heat and bonding using adhesive. The phrase “heat seal” refers to a bond made using heat and pressure.

As used herein, the symbols “Tg” and “T_{g}” are used with reference to the glass transition temperature of a polymer. Unless otherwise indicated, the glass transition temperature of the polymer was determined by the Perkin Elmer “half Cp extrapolated” (the “half Cp extrapolated” reports the point on the curve where the specific heat change is half of the change in the complete transition) following the ASTM D3418 “Standard Test Method of Transition Temperatures of Polymers by Thermal Analysis,” which is hereby incorporated, in its entirety, by reference thereto.

As used herein, the phrase “tie layer” refers to any internal layer having the primary purpose of adhering two layers to one another. Tie layers can comprise any polymer having a polar group grafted thereon. Such polymers adhere to both nonpolar polymers such as polyolefin, as well as polar polymers such as polyamide and ethylene/vinyl alcohol copolymer. Tie layers can be made from polyolefins such as modified polyolefin, ethylene/vinyl acetate copolymer, modified ethylene/vinyl acetate copolymer, and homogeneous ethylene/alpha-olefin copolymer. Typical tie layer polyolefins include anhydride modified grafted linear low density polyethylene, anhydride grafted (i.e., anhydride modified) low density polyethylene, anhydride grafted polypropylene, anhydride grafted methyl acrylate copolymer, anhydride grafted butyl acrylate copolymer, ethylene/methyl acrylate copolymer, homogeneous ethylene/alpha-olefin copolymer, maleic-anhydride modified polyethylene, maleic-anhydride modified linear low density polyethylene, and anhydride grafted ethylene/vinyl acetate copolymer.

“Ethylene homopolymer or copolymer” herein refers to ethylene homopolymer such as low density polyethylene; ethylene/alpha olefin copolymer such as those defined herein below; and other ethylene copolymers such as ethylene/vinyl acetate copolymer; ethylene/alkyl acrylate copolymer; ethylene/(meth)acrylic acid copolymer; or ionomer resin.

“High density polyethylene” (HDPE) herein refers to a polyethylene having a density of between 0.941 and 0.965 grams per cubic centimeter.

“Intermediate layer” herein refers to a layer of a multilayer film which is between an outer layer and an inner layer of the film.

“Inner layer” herein refers to a layer which is not an outer or surface layer, and is typically a central or core layer of a film.

“Low density polyethylene” (LDPE) herein refers to a polyethylene having a density of between 0.910 and 0.940 grams per cubic centimeter.

“Linear low density polyethylene” (LLDPE) herein refers to polyethylene having a density between 0.917 and 0.925 grams per cubic centimeter.

“Linear medium density polyethylene” (LMDPE) herein refers to polyethylene having a density between 0.926 grams per cubic centimeter and 0.939 grams per cubic centimeter.

“Outer layer” herein refers to what is typically an outermost, usually surface layer or skin layer of a multilayer film, although additional layers, coatings, and/or films can be adhered to it.

As used herein, the term “seal” refers to any seal of a first region of an outer film surface to a second region of an outer film surface, including heat or any type of adhesive material, thermal or otherwise. In some embodiments, the seal can be formed by heating the regions to at least their respective seal initiation temperatures. The sealing can be performed by any one or more of a wide variety of methods, including (but not limited to) using a heat seal technique (e.g., melt-bead sealing, thermal sealing, impulse sealing, dielectric sealing, radio frequency sealing, ultrasonic sealing, hot air, hot wire, infrared radiation).

As used herein, the phrases “seal layer”, “sealing layer”, “heat seal layer”, and “sealant layer”, refer to an outer film layer, or layers, involved in the sealing of the film to itself, another film layer of the same or another film, and/or another article that is not a film. It should also be recognized that in general, up to the outer 1-20 mils of a film can be involved in the sealing of the film to itself or another layer. In general, a sealant layer sealed by heat-sealing layer comprises any thermoplastic polymer. In some embodiments, the heat-sealing layer can comprise, for example, thermoplastic polyolefin, thermoplastic polyamide, thermoplastic polyester, and thermoplastic polyvinyl chloride. In some embodiments, the heat-sealing layer can comprise thermoplastic polyolefin.

As used herein, the term “extrusion” is used with reference to the process of forming continuous shapes by forcing a molten plastic material through a die, followed by cooling or chemical hardening. Immediately prior to extrusion through the die, the relatively high-viscosity polymeric material is fed into a rotating screw of variable pitch, which forces it through the die.

As used herein, the term “coextrusion” refers to the process of extruding two or more materials through a single die with two or more orifices arranged so that the extrudates merge and weld together into a laminar structure before chilling, i.e., quenching. Coextrusion can be employed in film blowing, free film extrusion, and extrusion coating processes.

As used herein, the phrase “machine direction”, herein abbreviated “MD”, refers to a direction “along the length” of the film, i.e., in the direction of the film as the film is formed during extrusion and/or coating.

As used herein, the phrase “transverse direction”, herein abbreviated “TD”, refers to a direction across the film, perpendicular to the machine or longitudinal direction.

As used herein, the phrase “free shrink” refers to the percent dimensional change in a 10 cm×10 cm specimen of film, when subjected to selected heat, as measured by ASTM D 2732, as known to those of skill in the art.

As used herein, the phrase “high barrier” and “high oxygen barrier” refers to an oxygen transmission rate of 1 to 10 cubic centimeters per square meter (cm3/m) or less (24 hours, 73° F. (22.8° C.), 1 atm (101.325 kPa), 0% humidity). The terms “high barrier” and “high oxygen barrier” are interchangeable.

All compositional percentages used herein are presented on a “by weight” basis, unless designated otherwise.

The invention may be directed to a package for packaging a meat product. The meat product may be beef, chicken, duck, fish, fresh red meat, goat, horse, lamb, pork, quail, rabbit, turkey, venison, or combinations thereof. The meat product may be comminuted meat, such as ground beef. The meat product may be roasts, steaks, fresh ham, smoked ham, and the like. The meat product may be a fresh meat product. The meat product may be fresh red meat. The meat product may be any meat product subject to the conversion of oxymyoglobin to deoxy myoglobin.

When fresh beef is vacuum packaged, the fresh beef is initially a bright red color due to oxymyoglobin color formation with absorption of atmospheric oxygen. When a high barrier film is used to package the fresh beef, the absence of oxygen causes the fresh beef to convert to deoxymyoglobin color (purple) when the reaction is complete. However, absorbed oxygen on the meat surface is partially depleted, and a partial pressure of oxygen is created, resulting in an intermediate pathway color known as metmyoglobin color (brown). This kind of browning of meat in vacuum skin packaging or other forms of vacuum packages is not acceptable to the consumers and leads to increased waste and business loss to the retailers as well as the meat processors. The consumer does find it acceptable for meat in vacuum skin packaging to have a purple color, such as meat that has undergone conversion of oxymyoglobin to deoxymyoglobin. This conversion should be completed before it reaches the retail case, preferably between 48-72 hours from when the meat is packaged. It is even more preferable for this conversion to be completed in less than 48 hours. The rate of the metmyoglobin side reaction is affected by a variety of factors such as storage temperature, muscle type of cut, and the film permeability to oxygen.

The package may be made from a single piece of film. The film may be a multilayer film. In some embodiments, the multilayer film may be an oxygen barrier film. In some embodiments, the multilayer film may be a high barrier film. In some embodiments, the multilayer film may be a high oxygen barrier film. The package may be a vacuum skin package. In some embodiments, the multilayer film may be an oriented multilayer film. In other embodiments, the multilayer film may not be an oriented multilayer film. In some embodiments, the multilayer film may be used as a top web of a VSP package, and the film of the present invention is substantially not oriented.

The multilayer films of the invention can be made by any suitable extrusion or co-extrusion process, either through a flat or a round extrusion dies, preferably by round cast or by hot blown extrusion techniques. Suitable round or flat coextrusion lines for coextruding the films of the invention are well known in the art.

In some embodiments, the multilayer film may be corona treated. The corona treatment may be on the surface of the multilayer film. The surface may be the food contact sealant layer or the abuse layer. In other embodiments, the multilayer film, or only one or more of the layers thereof, may be crosslinked. Crosslinking is aimed at improving the strength of the film and/or helping to avoid burn through during heat seal operations and at increasing the heat resistance of the film that has to be brought in contact with the heated dome.

The preferred method of crosslinking is by electron-beam irradiation and is well known in the art. One of skill in the art can readily determine the radiation exposure level suitable for a particular application. Generally, however, radiation dosages of up to about 250 kGy are applied, typically between about 80 kGy and about 240 kGy, with a preferred dosage of between 90 kGy and 230 kGy, and a most preferred one between 110 kGy and 220 kGy. Irradiation is carried out conveniently at room temperature, although higher and lower temperatures, for example, from 0° C. to 60° C. may be employed.

Chemical crosslinking agents may also be employed to provide the necessary crosslinking of at least one of the component films of the film. Such agents are typically added to a resin directly or by means of a master batch prior to extrusion of the blend.

In some embodiments, the present invention is a vacuum skin package comprising a support, a meat product loaded onto said support and a top skin film according to the present invention, said film being draped over the meat product and welded to the part of the support not covered by the product.

Any support or bottom web generally suitable for VSP applications may also be used within the package of the present invention, including both in-line thermoformed and off-line pre-made supports. Bottom web is typically a rigid or semi-rigid material or alternative a flexible material. In some embodiments, the bottom web is made of a multilayer film comprising, in addition to a heat sealable layer to allow welding of the twin skin film to the part of the support not covered by the product, at least one bulk layer for the mechanical properties.

In some embodiments, the multilayer film may have at least one food contact sealant layer, at least one barrier layer, and at least one abuse layer. In other embodiments, the multilayer film may have at least one food contact sealant layer, at least one tie layer, at least one barrier layer, and at least one abuse layer. In further embodiments, the multilayer film may have the following layers:
sealant/tie/barrier/tie/barrier/tie/barrier/tie/abuse;
sealant/tie/barrier/barrier/barrier/tie/abuse;
sealant/tie/barrier/tie/barrier/barrier/tie/abuse;
sealant/barrier/tie/barrier/barrier/tie/abuse;
sealant/barrier/tie/barrier/tie/barrier/abuse;
sealant/tie/barrier/barrier/barrier/tie/abuse;
sealant/tie/barrier/tie/barrier/tie/abuse;
sealant/tie/barrier/barrier/tie/abuse;
sealant/barrier/barrier/barrier/abuse;
sealant/barrier/tie/barrier/abuse;
sealant/barrier/barrier/abuse
sealant/barrier/abuse

The multilayer film may have a food contact sealant layer. The food contact sealant layer may be polyolefin, ethyl vinyl acetate (EVA), ionomers, polyethylene terephthalate (PET), polyethylene, or combinations thereof. In some embodiments, the food contact sealant layer may be a polyolefin. The food contact sealant layer may be LLDPE. The food contact sealant layer may be very low density polyethylene (VLDPE). The food contact sealant layer may be VLDPE and LLDPE. In other embodiments, the food contact sealant layer may be 80% VLDPE and 20% LLDPE.

The package may include a food additive in an amount sufficient to capture oxygen bound to myoglobin on the surface of the meat product. The food additive may be acerola extract, rosemary extract, dry vinegar, green tea extracts (with varying levels of polyphenols, catechins and caffeine), jasmine tea extract, grape seed extract, olive pulp, bamboo leaf, tocopherol succinate, vitamin E (d-alpha-tocopherol), vitamin C (ascorbic acid), vinegar (acetic acid), or combinations thereof. In some embodiments, the food additive may be water soluble. In other embodiments, the food additive may not be water soluble. The food additive may be a natural food additive. The food additive may be an antioxidant known to prevent rancidity or lipid oxidation.

In some embodiments, the food additive may be applied directly to the surface of the meat product. The food additive may be applied directly to the surface of the meat product before packaging the meat product. The food additive may be in an aqueous solution, and then applied directly to the surface of the meat product. The food additive may be applied by coating, dipping, misting, rinsing, showering, spraying, or washing the meat product.

The food additive may be applied to the food surface to maximize wetting of the meat product surface. In some embodiments, application of the food additive may completely cover the meat product surface. In other embodiments, the food additive may contact the meat product surface before the meat product surface is loaded into a package. In other embodiments, the food additive may contact the meat product surface after the meat product surface is loaded into a packaging material. In further embodiments, the food additive may contact the meat product surface as the same time the meat product surface is loaded into a package.

In some embodiments, the food additive may contact process water that contacts the meat product. In other embodiments, the food additive may contact the process water and then the process water with the food additive contacts the meat product.

In some embodiments, the food additive may contact a food processing surface before sanitation that comes into contact with the meat product. In other embodiments, the food additive may contact a food processing surface after sanitation that comes into contact with the meat product. In other embodiments, the food additive may contact the food processing surface and then the food processing surface with the food additive contacts the meat product. In other embodiments, the food additive may be first applied to a food processing surface and then the step of applying the food additive to a food surface is performed by the transference of the food additive from the food processing surface to the meat product after the meat product contacts the food processing surface.

The food additive may be applied to the multilayer film as a coating. In some embodiments, the food additive may be applied to the multilayer film as a dust coating. In other embodiments, the food additive may be applied to the multilayer film as a wet coating. The food additive may be applied to the multilayer film using an applicator. One example of an applicator may be a Myers rod. The food additive may be applied to the multilayer film using atomized spraying or vapor deposition. The multilayer film may be dried after applying the food additive. In some embodiments, the multilayer film may be dried for 10 seconds to 4 hours. The multilayer film may be dried for 10 seconds, 20 seconds, 30 seconds, 40 seconds, 45 seconds, 50 seconds, 60 seconds, 90 seconds, 120 seconds, 180 seconds, 240 seconds, 300 seconds, 10 minutes, 15 minutes, 20 minutes, 30 minutes, 45 minutes, 60 minutes, 1.5 hours, 2 hours, 2.5 hours, 3 hours, 3.5 hours, 4 hours, or any range between these values. In some embodiments, the coating may be prepared from an aqueous solution and allowed to dry naturally after applying to the multilayer film. A natural drying process may take seconds to hours, depending on the application and meat product. The coating may be formulated to be fast drying. In some embodiments, the aid of forced drying (e.g. driers) may be used to reduce the drying time. The drying time may be reduced significantly. The drying time may be reduced 10%, 15%, 20%, 30%, 40%, 50%, 60%, 70%, 80%, 90%, 95%, 96%, 97%, 98%, 99%, or any range between these values.

In some embodiments, the food additive may be incorporated into a multilayer film. The incorporating into the multilayer film may include extrusion, co-extrusion, surface coating, or dusting of the food additive into the multilayer film. The food additive may be contained on the sealant surface of the multilayer film with a spray application onto the sealant surface of the multilayer film. The sealant surface with the spray application would then make direct contact with the food surface.

The oxymyoglobin in the meat product converts to deoxymyoglobin within the package, the total myoglobin on the surface of the meat product contains less than 5% metmyoglobin within a time period of 36 hours or less from the time of packaging. In some embodiments, the meat product contains less than 15% metmyoglobin, 14% metmyoglobin, 13% metmyoglobin, 12% metmyoglobin, 11% metmyoglobin, 10% metmyoglobin, 9% metmyoglobin, 8% metmyoglobin, 7% metmyoglobin, 6% metmyoglobin, 5% metmyoglobin, 4% metmyoglobin, 3% metmyoglobin, 2% metmyoglobin, 1% metmyoglobin, 0.5% metmyoglobin on the surface of the meat product, or any range between these values. Metmyoglobin may be measured by chemical means, spectral readings, light reflection, light transmission methods or the like. For example, U.S. Pat. No. 5,088,822, the contents which are incorporated herein by reference, describes a measuring apparatus for analyzing pigment components of meat and corelating to % content of myoglobin. The time period of the conversion to deoxymyoglobin may be 36 hours or less. The time period of the conversion to deoxymyoglobin may be 36 hours, 34 hours, 32 hours, 30 hours, 28 hours, 26 hours, 24 hours, 22 hours, 20 hours, 18 hours, 16 hours, 14 hours, 12 hours, 10 hours, 8 hours, 6 hours, 4 hours, 2 hours, 1 hour, or any range between these values. In some embodiments, the time period of the conversion to deoxymyoglobin may be 24 hours or less.

The multilayer film may have at least one barrier layer. In some embodiments, the multilayer film may have 1 barrier layer, 2 barrier layers, 3 barrier layers, 4 barrier layers, 5 barrier layers, 6 barrier layers, 7 barrier layers, or any range between these values. In some embodiments, the multilayer film may have 2 barrier layers. In other embodiments, the multilayer film may have 3 barrier layers. The at least one barrier layer may be ethylene vinyl alcohol (EVOH), LDPE, LLDPE, VLDPE, EVA, polyamide, polyvinylidene chloride (PVDC), polyvinylidene chloride/methyl acrylate copolymer (PVDC-MA), or combinations thereof. In some embodiments, the at least one barrier layer may be VLDPE and EVA. In other embodiments, the at least one barrier layer may be VLDPE, LLDPE, and EVA. In further embodiments, the at least one barrier layer may be PVDC-MA. In some embodiments, the multilayer film may have 3 barrier layers, and the first barrier layer may be VLDPE, EVA, the second barrier layer may be PVDC-MA, and the third barrier layer may be VLDPE and EVA.

The multilayer film may have a tie layer. The multilayer film may have at least one tie layer adapted for improving the adherence of one layer of the film to another layer of the film. The tie layer may be EVA, EMA, LLDPE, LLDPE-md, maleic-anhydride-modified LDPE, or combinations thereof. The tie layer may be EVA. The tie layer may be EMA. The tie layer may be EVA and EMA. The multilayer film may have 1 tie layer. The multilayer film may have 2 tie layers. The multilayer film may have 3 tie layers. The multilayer film may have a plurality of tie layers. In some embodiments, the multilayer film may have 2 tie layers, the first tie layer may be EVA and the second tie layer may be EVA and EMA.

The multilayer film may have an abuse layer. The abuse layer is the layer of the multilayer film that will be in contact with the heated dome of the vacuum chamber in the VSP process. The abuse layer in VSP applications, typically comprise relatively high melting polyolefins, such as ethylene homo- and copolymers, propylene homo- and copolymers, ionomers, and (co)polyesters, i.e. PET-G, and their admixtures. In some embodiments, suitable melting points may be higher than 108° C., preferably higher than 120° C. The abuse layer may be LDPE, LLDPE, VLDPE, EVA, EMA, EVOH, polyamide, PVDC, PVDC-MA, or combinations thereof. In some embodiments, the abuse layer may be VLDPE. The abuse layer may be LLDPE. The abuse layer may be LLDPE and VLDPE.

The multilayer film of the present invention may have any total thickness, so long as the film provides the desired properties (e.g. formability, abuse, puncture resistance, machinability, seal strength etc.) for the particular packaging application.

For use as VSP top web the film of the present invention has preferably a total thickness of from about 25 to about 180 microns, preferably from about 30 to about 150 microns, more preferably from about 40 to about 120 microns, even more preferably from about 40 to about 100 microns.

For VSP, in particular, thicker films will be used for packaging products of higher profile while thinner film are sufficient and preferred in order to vacuum skin package products with a shallow profile. Generally, the films of the present invention are advantageous with respect to current VSP films on the market, providing comparable performances with lower thicknesses.

In particular, thicker films i.e. 100 microns or more, are suitable for demanding applications like packaging of high profile products and/or with irregular and sharp surfaces, such as bone-in meat or frozen products or crabs and the like.

One or more of any of the layers of the multilayer film of the present invention may include appropriate amounts of additives typically included in structures for food packaging for the desired effect, as it is known to one of skill in the packaging films art. For example, a layer may include additives such as slip agents, antiblock agents, antioxidants, fillers, dyes and pigments, crosslinking enhancers, crosslinking inhibitors, radiation stabilizers, oxygen scavengers, antistatic agents, and the like agents.

The VSP process comprises the steps of placing a meat product loaded support in a vacuum chamber, positioning the multilayer film of the present invention above the product loaded support, allowing the multilayer film to drape itself over the product and to weld to the part of the support not covered by the meat product to obtain a vacuum skin package.

In more detail, the multilayer film of the present invention is used to form the skin, and is fed to the upper section of a heated vacuum chamber comprising an upper and a lower section, and a vacuum is applied thereto from the outside, thereby drawing the skin-forming film into a concave form against the inwardly sloping walls of the upper section of the chamber and against the ports contained in the horizontal wall portion thereof (the top of the dome). Any conventional vacuum pump can be used to apply the vacuum and preferably the skin-forming multilayer film is suitably pre-heated prior to the foregoing operation to render it more formable and thus better able to assume a concave shape in the upper section of the vacuum chamber. The meat product to be packaged is positioned on a support member that can be flat or shaped, typically tray-shaped, and placed on a platform that is carried in the vacuum chamber, in the lower section thereof, just below the dome. The support member can be shaped off-line or, alternatively, in-line at an initial station on the vacuum packaging machine. Then the vacuum chamber is closed by moving the upper section down onto the lower one and during this whole sequence of operations vacuum is constantly applied to retain the concave shape of the film. Once the vacuum chamber is closed, vacuum is applied also in the lower section of the vacuum chamber in order to evacuate the space between the support member and the top skin-forming film. Vacuum in the upper section of the vacuum chamber continues to be applied to retain the concave shape of the skin-forming film until the area between the support and the skin-forming film is evacuated, then it is released and atmospheric pressure is admitted. This will collapse the softened top skin-forming film over the product and the support, as the atmosphere pushing the skin-forming film from the top and the vacuum pulling it from the bottom will cooperatively work to have the skin-forming film substantially conform to the shape of the product to be packaged on the support member.

Optionally, after the evacuation step has been completed, a suitably selected purging gas or gas mixture could be flushed over the product to generate a very low residual gas pressure into the package. In some embodiments, gas purging may be done if the VSP is oxygen permeable and an additional oxygen barrier lidding is applied over the top of the VSP and sealed to the perimeter with a low oxygen gas. This low oxygen gas will create a deoxymyoglobin color (purple). Additionally, this lidding over the VSP may be removed later for the function of “rebloom” of the meat product by atmospheric oxygen permeating the oxygen permeable VSP film. In some instances, heat-sealing bars or other sealing means can be present in the vacuum chamber to carry out a perimeter heat-seal of the skin-forming film to the support member.

The multilayer film may be made into a package. The package may be a barrier package. The barrier package may be a flexible thermoformed oxygen barrier package with a low oxygen atmosphere, a rigid thermoformed oxygen barrier package with a low oxygen modified atmosphere, a non-shrink flexible pouch with a low oxygen atmosphere, an evacuated shrinkable barrier bag, an evacuated non-shrink flexible pouch, an evacuated oxygen permeable film package with a low oxygen gas flushed rigid container, an oriented bag, a non-oriented flexible pouch, a barrier bag, or combinations thereof.

The package may be used for packaging a meat product. The meat product may initially be a bright red color due to oxymyoglobin present on the surface of the meat product due to absorption of atmospheric oxygen. In some embodiments, the package may be a barrier package and have the absence of oxygen in the package. This absence of oxygen causes the meat product, preferably a fresh meat product, more preferably a fresh red meat product, to convert the oxymyoglobin (red color) to deoxymyoglobin (purple color). However, there may be absorbed oxygen on the surface of the meat product, and it is partially depleted, creating a partial pressure of oxygen. This results in an intermediate pathway color known as metmyoglobin (brown color). The rate of the metmyoglobin side reaction is affected by a variety of factors such as storage temperature, the muscle type in the cut of meat, the film permeability to oxygen, etc. The conversion of metmyoglobin to deoxymyoglobin is a much slower process, particularly under refrigerated storage conditions. The multilayer film of the present invention with the addition of the food additive, in an amount sufficient to capture oxygen bound to myoglobin on the surface of the meat product, may increase the conversion rate of oxymyoglobin to deoxymyoglobin. The conversion rate may be reduced to 36 hours or less. The conversion rate may be 24 hours or less. The conversion rate reduction results with less than 5% metmyoglobin remaining on the surface of the meat product. In some embodiments, the conversion rate may be 24 hours or less with less than 1% metmyoglobin remaining on the surface of the meat product. In other embodiments, the conversion rate may be 18 hours or less with less than 5% metmyoglobin remaining on the surface of the meat product.

In some embodiments, the package may be an oxygen permeable vacuum package. The oxygen permeable vacuum package may have a meat product and a food additive inside the package, where the food additive has been applied to the surface of a meat product. The oxygen permeable vacuum package may be enclosed with a low oxygen modified atmosphere barrier package. The oxygen permeable vacuum package may be case ready.

A method for the conversion of metmyoglobin to deoxymyoglobin on the surface of a meat product is disclosed. The method may include providing a multilayer film. The multilayer film may have a food contact sealant layer. The food contact sealant layer may be a polyolefin, EVA, an ionomer, PET, polyethylene, or combinations thereof. In some embodiments, the food contact sealant layer may be a plurality of polyolefins. In other embodiments, the food contact sealant layer may be a plurality of ionomers. In further embodiments, the food contact sealant layer may be a plurality of polyethylenes.

The method may further include adding a food additive. The food additive may be added in an amount sufficient to capture oxygen bound to myoglobin on the surface of the meat product to the multilayer film. The amount sufficient to capture oxygen bound to myoglobin on the surface of the meat product may be a coating of the food additive on the surface of the meat product that covers about 75% of the surface of the meat product, about 80% of the surface of the meat product, about 85% of the surface of the meat product, about 90% of the surface of the meat product, about 92% of the surface of the meat product, about 94% of the surface of the meat product, about 95% of the surface of the meat product, about 96% of the surface of the meat product, about 97% of the surface of the meat product, about 98% of the surface of the meat product, about 99% of the surface of the meat product, or any range between these values. In other embodiments, the amount sufficient to capture oxygen bound to myoglobin on the surface of the meat product may be a coating of the food additive on the food contact sealant surface. The coating may be 0.001 grams/square inches (g/sq. inch) to 0.5 g/sq. inch solids content of the food contact sealant layer. The coating may be 0.005 g/sq. inch to 0.01 g/sq. inch solids content of the food contact sealant layer. In some embodiments, the coating may be 0.001 g/sq. inch, 0.002 g/sq. inch, 0.004 g/sq. inch, 0.006 g/sq. inch, 0.008 g/sq. inch, 0.01 g/sq. inch, 0.02 g/sq. inch, 0.04 g/sq. inch, 0.05 g/sq. inch, 0.06 g/sq. inch, 0.075 g/sq. inch, 0.08 g/sq. inch, 0.09 g/sq. inch, 0.1 g/sq. inch, 0.2 g/sq. inch, 0.3 g/sq. inch, 0.4 g/sq. inch, 0.5 g/sq. inch, or any range between these values.

The method may also include forming a barrier package from the multilayer film. The step of forming a barrier package may be formed as described above. The forming a barrier package may be forming a VSP as discussed above. The step of forming a barrier package may be any forming of a barrier package method that is well known in the art. The method may also include placing a meat product inside the barrier package. The meat product may contact the food additive. The meat product may contact the food additive before being placed inside the package. The food additive may be added to the surface of the meat product before placing the meat product inside the barrier package. The meat product may contact the food additive after being placed inside the package. The method my further include sealing the barrier package closed. The barrier package may be sealed with the meat product inside the barrier package. Once the package has been sealed with the meat product inside the package, the meat product may have a conversion rate of oxymyoglobin to deoxymyoglobin with less than 5% metmyoglobin remaining on the surface of the meat product within a time period of 36 hours or less. The meat product may be beef, chicken, duck, fish, fresh red meat, goat, horse, lamb, pork, quail, rabbit, turkey, venison, or combinations thereof. The meat product may be comminuted meat, such as ground beef. The meat product may be roasts, steaks, fresh ham, smoked ham, and the like. The meat product may be a fresh meat product. The meat product may be fresh red meat. The meat product may be any meat product subject to the conversion of oxymyoglobin to deoxymyoglobin.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### EXAMPLES

### Example 1: Multilayer Film Formulations

The various resins and other components used in the making of the films are provided in Table 1, below.

TABLE 1

| | | | Melt Flow | |
|---|---|---|---|---|
| | | | Index | |
| | | | (MFI) | |
| | | Density | g/10 | |
| Acronym | Chemical Nature | (g/cm3) | minutes | Supplier |
| VLDPE1 | Polyethylene, Very Low | 0.920 | 1.0 | Dow |
| | Density Ethylene/Octene | | | |
| | Copolymer - Branched, | | | |
| | Single Site | | | |
| LLDPE1 | Polyethylene, Linear Low | 0.921 | 1.0 | Dow |
| | Density Ethylene/Hexene | | | |
| | Copolymer - Linear, | | | |
| | Ziegler/Natta | | | |
| VLDPE2 | Polyethylene, Very Low | 0.92 | 1.0 | Dow |
| | Density Ethylene/Octene | | | |
| | Copolymer - Linear, | | | |
| | Ziegler/Natta | | | |
| VLDPE3 | Polyethylene, Very Low | 0.92 | 1.0 | Dow |
| | Density Ethylene/Hexene | | | |
| | Copolymer - Linear, | | | |
| | Ziegler/Natta | | | |
| EVA1 | Ethylene/Vinyl Acetate | 1.06 | 3.08 | DuPont |
| | Copolymer - Between 10-20 | | | |
| | wt % comonomer | | | |
| EVA2 | Ethylene/Vinyl Acetate | 1.06 | 3.08 | DuPont |
| | Copolymer - Between 10-20 | | | |
| | wt % comonomer | | | |
| VLDPE4 | Polyethylene, Very Low | 0.92 | 1.0 | Dow |
| | Density Ethylene/Octene | | | |
| | Copolymer - Linear, Single | | | |
| | Site | | | |
| VLDPE5 | Polyethylene, Very Low | 0.92 | 1.0 | Dow |
| | Density Ethylene/Octene | | | |
| | Copolymer - Linear, Single | | | |
| | Site | | | |
| EVA/ | 83% Ethylene/Vinyl | 1.036 | 2.72 | DuPont |
| VLDPE | Acetate Copolymer - | | | |
| | Between 10-20 wt % | | | |
| | comonomer/17% | | | |
| | Polyethylene, Very Low | | | |
| | Density Ethylene/Octene | | | |
| | Copolymer - Linear, Single | | | |
| | Site | | | |
| EVA3 | Ethylene/Vinyl Acetate | 1.06 | 3.08 | DuPont |
| | Copolymer - Between 10-20 | | | |
| | wt % comonomer | | | |
| EVA4 | Ethylene/Vinyl Acetate | 1.06 | 3.08 | DuPont |
| | Copolymer - More than 20 | | | |
| | wt % comonomer | | | |
| EVA5 | Ethylene/Vinyl Acetate | 1.06 | 3.08 | DuPont |
| | Copolymer - More than 20 | | | |
| | wt % comonomer | | | |
| PVDC- | Vinylidene Chloride/Methyl | 1.65 | 2.5 | Solvay |
| MA1 | Acrylate Copolymer - | | | |
| | Stabilized | | | |
| PVDC- | Vinylidene Chloride/Methyl | 1.65 | 2.5 | Solvay |
| MA2 | Acrylate Copolymer - | | | |
| EMA | Ethylene/Methyl Acrylate | 0.943 | 2.0 | Exxon |
| | Copolymer - Between 10-20 | | | |
| | wt % comonomer | | | |
| EVA6 | Ethylene/Vinyl Acetate | 1.06 | 3.08 | DuPont |
| | Copolymer - More than 20 | | | |
| | wt % comonomer | | | |
| LLDPE2 | Polyethylene, Linear Low | 0.921 | 1.01 | Dow |
| | Density Ethylene/Octene | | | |
| | Copolymer - Linear, | | | |
| | Ziegler/Natta | | | |
| VLDPE6 | Polyethylene, Very Low | 0.92 | 1.0 | Dow |
| | Density Ethylene/Hexene | | | |
| | Copolymer - Linear, | | | |
| | Ziegler/Natta | | | |
| VLDPE7 | Polyethylene, Very Low | 0.921 | 1.0 | Dow |
| | Density Ethylene/Octene | | | |
| | Copolymer - Branched, | | | |
| | Single Site | | | |
| VLDPE8 | Polyethylene, Very Low | 0.920 | 1.0 | Dow |
| | Density Ethylene/Octene | | | |
| | Copolymer - Linear, | | | |
| | Ziegler/Natta | | | |
| LLDPE3 | Polyethylene, Linear Low | 0.921 | 1.01 | Dow |
| | Density Ethylene/Octene | | | |
| | Copolymer - Linear, | | | |
| | Ziegler/Natta | | | |
| LLDPE4 | Polyethylene, Linear Low | 0.920 | 1.0 | Dow |
| | Density Ethylene/Hexene | | | |
| | Copolymer - Linear, Single | | | |
| | Site | | | |
| LLDPE5 | Polyethylene, Linear Low | 0.92 | 1.01 | Dow |
| | Density Ethylene/Octene | | | |
| | Copolymer - Linear, | | | |
| | Ziegler/Natta | | | |
| LLDPE6 | Fluoropolymer in | 0.92 | 1.0 | Dow |
| | Polyethylene, Linear Low | | | |
| | Density | | | |
| VLDPE9 | Polyethylene, Very Low | 0.92 | 1.0 | Dow |
| | Density Ethylene/Butene | | | |
| | Copolymer - Linear, Single | | | |
| | Site | | | |
| LLDPE/ | 50% Primary and Secondary | 0.921 | 1.0 | Exxon |
| LLDPE | AntiOxidant in | | | |
| | Polyethylene, Linear Low | | | |
| | Density/50% Fluoropolymer | | | |
| | in Polyethylene, Linear Low | | | |
| | Density | | | |

Samples of multilayer films were used to make a package for a meat product. The formulation of the prepared Sample 1 is listed in Table 2 below.

TABLE 2

| Film | | Thickness | Finished | |
|---|---|---|---|---|
| Layer | Layer Composition | (%) | (microns) | Crosslinked |
| 1 | 80% VLDPE1, | 21.65 | 11 | Yes |
| | 20% LLDPE1 | | | |
| 2 | 70% VLDPE2/VLDPE3 | 38.96 | 19.8 | Yes |
| 3 | 100% EVA1/EVA2/EVA4/ | 4.33 | 2.2 | Yes |
| | EVA5 | | | |
| 4 | 100% PVA-MD1/ | 9.09 | 4.6 | No |
| | PVA-MD2 | | | |
| 5 | 100% EVA5/EVA4/EMA/ | 4.33 | 2.2 | No |
| | EVA6 | | | |
| 6 | 70% VLDPE2/VLDPE3/ | 12.99 | 6.6 | No |
| | LLDPE2, | | | |
| | 30% EVA3/EVA2 | | | |
| 7 | 80% VLDPE7/VLDPE8 | 8.66 | 4.4 | No |
| | 20% LLDPE3/LLDPE4/ | | | |
| | LLDPE5 | | | |

Variations of Sample 1 were also prepared. Layer 2, a barrier layer, had two additional formulations. Layer 2 had a second formulation with 64% VLDPE3, 30% EVA1/EVA2, and 6% VLDPE4/VLDPE5. Layer 2 had a third formulation with 64% VLDPE3 and 36% EVA/VLDPE. Layer 6, also a barrier layer, had two additional formulations. Layer 6 had a second formulation with 64% VLDPE3/VLDPE6, 30% EVA1/EVA2, and 6% VLDPE4/VLDPE5. Layer 6 had a third formulation with 64% VLDPE3/VLDPE6 and 36% EVA/VLDPE. Layer 7, an abuse layer, had two additional formulations. Layer 7 had a second formulation with 80% VLDPE7/VLDPE8, 19% LLDPE3/LLDPE4/LLDPE5, and 1% LLDPE. Layer 7 had a third formulation with 79% VLDPE9, 19% LLDPE5, and 2% LLDPE/LLDPE. All testing done in examples 1-3 were completed with Sample 1.

### Example 2: Direct Application of Additive to Food Surface

The various additives that were tested are listed below in Table 3.

TABLE 3

| | Physical | | |
|---|---|---|---|
| Additive Name | State | Active Ingredient | Supplier |
| Guardox AE | Solid powder | Acerola Extract (Ascorbic acid) | Handary |
| Shelfex | Solid powder | Dry Vinegar (Acetic Acid) + Jasmine | Handary |
| | | Tea Extract | |
| Guardox BL | Solid powder | Bamboo Leaf extract | Handary |
| Guardox OP | Solid powder | Olive Pulp extract | Handary |
| Vitamin C | Solid powder | l-Ascorbic Acid | Sigma |
| Vinegar | Liquid | Acetic acid | Sigma |
| Mixed Tocopherols | Viscous liquid | d-alpha-tocopherol (Vitamin E) | Scoular |
| Tocopheryl succinate | Solid powder | Tocopherol succinate | Scoular |
| Sunphenon 90D | Solid powder | polyphenols >90%, catechins >80%, | Taiyo |
| | | EGCg >45%, caffeine <1% | |
| Sunphenon OS2 | Viscous paste | Green tea extract (polyphenols) | Taiyo |

Fresh beef samples were cut from a top-round (or bottom-round) sub-primal. Such samples were then sliced into two parts—a control and a treatment having paired surfaces, and cut into 3″×3″ squares. All the paired samples were left exposed to ambient air under refrigerated conditions for three hours. Next, the surface of a sample was coated with a known quantity of one of the natural additives (for example, acerola extract). Both the treated sample and the paired control were then packaged in a high barrier bag and vacuum-sealed.

The samples and paired controls were stored under refrigeration and monitored over the course of 24-36 hours since packaging. The natural additive was rapidly absorbed onto the surface of meat and was no longer visible as particulates. A Minolta Colorimeter was used to take color readings (L, a*, and b* values) from the paired surfaces. The colorimetric readings at of each treated sample and the paired control were compared at the end of 24 hours. The color differences are given in Table 4 below.

It was noted that the treated samples turned purple within 24 hours while the paired controls were still brown for several hours beyond the first 24 hours. The color difference of the treated compared to the control was 3.60. These results indicate that the treatment accelerated the natural conversion process from brown (metmyoglobin) to purple (deoxymyoglobin) color in meat.

TABLE 4
Colorimetric results for Acerola Extract treatment after 24 hrs

| | | | | Color | |
|---|---|---|---|---|---|
| Sample Type | L value | a* value | b* value | Difference | Visual Observation |
| Control | 68.59 | 20.16 | −6.39 | | Brownish patches on meat |
| Treated | 68.99667 | 21.51 | 6.65333 | 3.60 | Meat fully converted to purple. |

### Example 3: Coated Packaging Films

Aqueous solutions of the natural additives were prepared in various concentrations. The sealant surface of a high barrier film (Sample 1) was corona-treated to improve its adhesion property. Myers' rods, numbered 30 and 60, were used to make coatings (with 0.005-0.01 g/sq. inch solids content) on the corona-treated sealant surface. The coated film samples were dried for at least 24 hrs and were then sealed on three sides to make bags.

Fresh beef samples were cut from a top-round (or bottom-round) sub-primal. Such samples were then sliced into two—a control and a treatment having paired surfaces, and cut into 3″×3″ squares. All the paired samples were left exposed to ambient air under refrigerated conditions for three hours.

The samples were packaged in the coated high barrier bags while the paired controls were packaged in uncoated high barrier bags. The uncoated and coated barrier bags had the same multi-layer film composition and therefore, the same oxygen transmission rate. All the packages were vacuum-sealed.

The samples and paired controls were stored under refrigeration and monitored over the course of 24-36 hrs since packaging. A Minolta Colorimeter was used to take color readings (L, a*, b* values) from the paired surfaces. The colorimetric readings at of each sample and the paired control were compared at the end of 24 hrs. The color differences are given in Table 5 below.

TABLE 5
Colorimetric results for Acerola Extract Coating after 24 hrs

| | | | | Color | |
|---|---|---|---|---|---|
| Sample Type | L value | a* value | b* value | Difference | Visual Observation |
| Control | 71.06333 | 22.90667 | −5.43 | | Brownish patches on meat. |
| Coated | 71.56333 | 21.59333 | 4.94333 | 2.78 | Meat fully converted to purple. |

It was noted that the samples turned purple within 24 hours while the paired controls were still brown. The color difference of the coated compared to the control was 2.78. These results indicate that the film coating was absorbed the meat on contact and thereby, accelerated the natural conversion process from brown (metmyoglobin) to purple (deoxymyoglobin) color in meat.

1. A package for packaging a meat product, comprising:
a. a multilayer film comprising a food contact sealant layer comprising at least one member selected from the group consisting of polyolefins, EVA, ionomers, PET, and polyethylene; and
b. a food additive in an amount sufficient to capture oxygen bound to myoglobin on the surface of the meat product,
wherein the oxymyoglobin in the meat product converts to deoxymyoglobin within the package, the total myoglobin on the surface of the meat product contains less than 5% metmyoglobin within a time period of 36 hours or less from the time of packaging.

2. The package of claim 1, wherein the food additive comprises at least one member selected from the group consisting of acerola extract, rosemary extract, dry vinegar, green tea extracts, jasmine tea extract, grape seed extract, olive pulp, bamboo leaf, tocopherol succinate, d-alpha-tocopherol, ascorbic acid, and acetic acid.

3. The package of claim 1, wherein the multilayer film is a high oxygen barrier film.

4. The package of any one of claim 1, wherein the package is a vacuum skin package.

5. The package of any one of claim 1, wherein the food additive is applied to the multilayer film as a coating.

6. The package of claim 5, wherein the food additive is applied to the food contact layer of the multilayer film as a dust coating.

7. The package of claim 5, wherein the food additive is applied to the food contact layer of the multilayer film as a wet coating.

8. The package of claim 1, wherein the food additive is incorporated into the food contact layer of the multilayer film.

9. The package of claim 1, wherein the food additive is water soluble.

10. The package of claim 1, wherein the meat product is fresh red meat.

11. The method of any one of claim 1, wherein the time period is 24 hours or less.

12. The method of any one of claim 1, wherein the multilayer film is an oriented multilayer film.

13. The method of any one of claim 5, wherein the coating contains between 0.001 grams/square inches to 0.5 grams/square inches solids.

14. A method for the conversion of metmyoglobin to deoxymyoglobin on the surface of a meat product, comprising:
a. providing a multilayer film comprising a food contact sealant layer comprising at least one member selected from the group consisting of polyolefins, EVA, ionomers, PET, and polyethylene;
b. adding a food additive in an amount sufficient to capture oxygen bound to myoglobin on the surface of the meat product to the multilayer film;
c. forming a barrier package from the multilayer film;
d. placing a meat product inside the barrier package, wherein the meat product contacts the food additive; and
e. sealing the barrier package closed with the meat product inside the barrier package,
wherein the oxymyoglobin in the meat product converts to deoxymyoglobin within the package, the total myoglobin on the surface of the meat product contains less than 5% metmyoglobin within a time period of 36 hours or less from the time of packaging.

15. The method of claim 14, wherein the food additive is applied to the multilayer film as a dust coating or a wet coating.

16. (canceled)

17. (canceled)

18. The method of claim 14, wherein the food additive is incorporated into the food contact layer of the multilayer film.

19. The method of any one of claim 14, wherein the food additive is water soluble.

20. (canceled)

21. The method of any one of claim 14, wherein the time period is 24 hours or less.

22. The method of any one of claim 14, wherein the barrier package comprises at least one member selected from the group consisting of a flexible thermoformed oxygen barrier package with a low oxygen atmosphere, a rigid thermoformed oxygen barrier package with a low oxygen modified atmosphere, a non-shrink flexible pouch with a low oxygen atmosphere, an evacuated shrinkable barrier bag, an evacuated non-shrink flexible pouch, an evacuated oxygen permeable film package with a low oxygen gas flushed rigid container, an oriented bag, a non-oriented flexible pouch, and a barrier bag.

23. A method for the conversion of oxymyoglobin to deoxymyoglobin on the surface of a meat product, comprising:
a. providing a multilayer film comprising a food contact sealant layer comprising at least one member selected from the group consisting of polyolefins, EVA, ionomers, PET, and polyethylene;
b. adding a food additive in an amount sufficient to capture oxygen bound to myoglobin on the surface of the meat product to the surface of the meat product;
c. forming a barrier package from the multilayer film; and
d. placing a meat product inside the barrier package, wherein the food additive has been added to the surface of the meat product before placing the meat product inside the barrier package; and
e. sealing the barrier package closed with the meat product inside the barrier package,
wherein the oxymyoglobin in the meat product converts to deoxymyoglobin within the package, the total myoglobin on the surface of the meat product contains less than 5% metmyoglobin within a time period of 36 hours or less from the time of packaging.

24. (canceled)

25. (canceled)

26. (canceled)
